(19) United States
(12) Patent Application Publication
(10) Pub. No.: US 2003/0142057 A1
(43) Pub. Date: Jul. 31, 2003

(54) Information display, method for preparing it and method for using it

(75) Inventors: Satoshi Niiyama, Kanagawa (JP); Noriko Suehiro, Kanagawa (JP); Shinya Tahara, Kanagawa (JP); Hitoshi Tsushima, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: OPTREX Corporation, Tokyo (JP)

(21) Appl. No.: 10/309,271

(22) Filed: Dec. 4, 2002

(30) Foreign Application Priority Data
Dec. 6, 2001 (JP) 2001-373274
Sep. 27, 2002 (JP) 2002-282562

(51) Int. Cl. G09G 3/36

(52) U.S. Cl. 345/97; 40/448

(57) ABSTRACT

An information display comprises a planar electrical optical element including a plurality of pixels, each of the pixels having an optical state controlled by an electrical signal; the optical element having at least two optical states of a light scattering state and a light transmissive state, each of the pixels having the optical state reversibly changed between the scattering state and the light transmissive state; information being displayed in a planar fashion by combining the optical states of pixels; and the information being capable to be held with no electrical signal applied, and visible light having a transmittance of 60% or higher when the visible light passes from one of surfaces of the electrical optical element to the other surface through a pixel in the light transmissive state.

The present invention relates to an information display, a method for preparing it and a method for using it.

Many information displays have been used. In a first prior art case, a colored portion or a non-transparent portion is formed on a transparent background to display an information image, such as a character and a design, thereon. For example, an information image has been displayed on a glass sheet for an exterior material at a shop building by printing, painting or another way.

When a glass sheet is used in an exterior side of a shop building, external light can be taken into the shop, and the inside of the shop is visible from a street side. This arrangement is expected to be used for promoting advertisement to customers. Information on bargain days or the advertisement of specific merchandise has been made by directly printing the information or the advertisement on a sheet or putting a poster about the information or the advertisement on the glass sheet of the shop.

Showcases or show windows for displaying merchandise have used a glass sheet. A leaflet or the like has been put in a showcase to explain merchandise. Merchandise is displayed with a decoration or a leaflet appropriate to the image thereof put at a position close thereto in a show window. The leaflet or the decoration, which is displayed for promoting the sales of the merchandise, has been manually discarded, replaced or changed, depending on a change in the merchandise to be displayed or seasons.

A railway car, such as an electric railway car, is provided with a transparent member in a portion of a door between railway cars. When the door is opened or closed, a passenger can make sure through the transparent member whether another passenger is coming toward him or her from the railway car. The transparent member has had an information image on the car number or other information displayed thereon.

A second prior art case is related to information displays provided in many sorts of meeting places, such as a wedding ceremony hall, a funnel hall, a convention center and an exhibition. Many sorts of information display boards have been used to make guidance or provide information on directions or a way to a waiting room in a place where many people gather. In order to have a good appearance or to allow everyone to see the circumstance behind the information display boards, some of the information display boards have provided information by printing the information image on a glass sheet or a resin plate.

A third prior art case is related to an information display, which is provided at the reception of a corporation, a bank teller's window, a counter in a public office or another place. Each of these places has a partition made of a transparent member provided thereon in general. A clerk at each of these places has dealt with his or her job, facing a customer through the partition. In this case, an information display is usually provided at a position close to the partition to provide customers with necessary information.

A fourth prior art case is related to an information display provided at a position close to the instrument panel of an automobile. The driver in an automobile needs information on equipment of the automobile and driving operation in real time. These pieces of information are displayed on a display separately provided. The driver needs to take a look at information on external circumstances through the windshield and simultaneously take a look at information to be provided by the display. If a conventional display is provided on the windshield, the display is supposed to prevent the driver from recognizing the information on external circumstances since the display has not had sufficient transparency in a screen area. This has made it difficult to provide a display at a position close to the windshield.

A fifth prior art case is related to an information display, which is provided in an arcade game machine, such a pachinko machine and a pinball machine. In many cases, a transparent member is used on a front side of game equipment including a mechanical system or a display screen of game equipment. That sort of transparent member has a display provided therebehind to convey information on the game to a player. Game equipment usually has the outermost side made of a transparent member, such as a glass sheet, in terms of protection for the essential parts of the game equipment. A required display is provided behind the glass sheet since the glass sheet per se has no display ability.

There have been known various sorts of displays for providing information. There have been mainly proposed displays, which can change an information image by an electric signal as desired. There have been known a photochromic display, an electrochromic window (ECW), a TN liquid crystal display, an STN liquid crystal display, a liquid crystal window (LCW), a display with a liquid crystal/polymer composite, which has a transmission-scattering drive mode and causes polymerization by application of an electric field (the patent document 1 listed below), a ferroelectric liquid crystal display, a chiral nematic liquid crystal display and the like.

The chiral nematic liquid crystal display among the liquid crystal displays has been known for a long time (the patent documents 2 and 3, and the non-patent document 1 listed below). With regard to cell structures, liquid crystal materials, chiral additives, methods for setting selectively reflected light, alignment layers, driving methods and the like, recently developed technologies have been disclosed in the patent documents 4 to 7 listed below. A method wherein an alignment layer in contact with a chiral nematic liquid crystal layer is provided so as to have a pretilt angle of 60 deg or greater has been disclosed in the patent document 8 listed below.

Patent Document 1: U.S. Pat. No. 4,818,070

Patent Document 2: U.S. Pat. No. 3,936,815

Patent Document 3: U.S. Pat. No. 4,097,127

Patent Document 4: U.S. patent application Ser. No. 2002/0036614 A1

Patent Document 5: U.S. patent application Ser. No. 2002/0047819 A1

Patent Document 6: U.S. patent application Ser. No. 2002/0122148 A1

Patent Document 7: U.S. patent application Ser. No. 2002/0126229 A1

Patent Document 8: JP-A-2001-343648

Non-Patent Document 1: George H. Heilmeier, Joel E. Goldmacher et al, Appl. Phys. Lett., 13(1968), 132

The technique in the first prior art case needs human hands. It has not been easy to change information frequently and timely. In the second and third prior art cases, it has been difficult to exhibit a completely transparent state, depending on circumstances, when a conventional display, such as a TN liquid crystal display, is provided side by side with a transparent member. Additionally, it has been necessary to install a separate display unit.

When a display having an advanced display function is combined with a transparent member to provide information, the display has been insufficient in recognition of the circumstances on a rear side therethrough since the display is as low as 40% or lower in transmittance. For example, automobile instruments are collectively provided on the instrument panel to display pieces of information. From the viewpoint of minimizing the movement of the eyes of a driver while driving, it is preferable that the display is provided at a position close to the windshield. The conventional displays have been not suited to be provided at a position close to windshields since the conventional displays have a low transmittance and is a bar to sight to external circumstances.

The LCW and the ECW have generated problems in terms of image rewriting speed, power consumption and ease in drive. The LCW and the ECW have been difficult to continuously hold a displayed image without being energized or driven.

Although a chiral nematic liquid crystal display per se, which has a memory type of operation mode, has been known, there has not been known liquid crystal window, which appears to display an information image on a transparent background.

It is an object of the present invention to solve these problems and to provide an information display capable of displaying an information image on a transparent background having a high transmittance and holding the displayed image even when the display is shut off from being driven or energized after the information image has been written. It is another object of the present invention to provide an information display capable of rewriting, holding an information image at low power consumption and being easier to be handled in comparison with the prior art.

According to a first aspect of the present invention, there is provided an information display comprising a planar electrical optical element including a plurality of pixels, and each of the pixels having an optical state controlled by an electrical signal; characterized in that the optical element has at least two optical states of a light scattering state and a light transmissive state, each of the pixels has the optical state reversibly changed between the scattering state and the light transmissive state; an information image is displayed in a planar fashion by combining the optical states of pixels; and the information image is capable to be held with no electrical signal applied, and visible light having a transmittance of 60% or higher when the visible light passes from one of surfaces of the electrical optical element to the other surface through a pixel in the light transmissive state. It is preferable that the transmittance is 70% or higher.

According to a second aspect of the present invention, there is provided the information display according to the first aspect, wherein the electrical optical element comprises a liquid crystal optical element, which has a liquid crystal sandwiched between a pair of substrates with transparent electrodes provided thereon, the liquid crystal having a memory effect in its operation capable of holding two or more optical states with no voltage applied, the optical states being changed by a voltage pulse.

According to a third aspect of the present invention, there is provided the information display according to the second aspect, wherein the liquid crystal is a chiral nematic liquid crystal.

According to a fourth aspect of the present invention, there is provided the information display according to the third aspect, wherein when the chiral nematic liquid crystal exhibits a planar state, at least part of selectively reflected light contains infrared light.

According to a fifth aspect of the present invention, there is provided the information display according to the third aspect or the fourth aspect, wherein a resin layer is arranged to have a pretilt angle of 60 deg or greater in contact with the chiral nematic liquid crystal.

According to a sixth aspect of the present invention, there is provided the information display according to the fifth aspect, wherein the resin layer has at least one side subjected to rubbing treatment.

According to a seventh aspect of the present invention, there is provided the information display according to the second aspect, the third aspect, the fourth aspect, the fifth aspect or the sixth aspect, wherein the transparent electrodes are configured to display an information image in a dot matrix pattern by use of matrix electrodes, or the transparent electrodes are configured to display an information image in a segment pattern by use of segment electrodes.

According to an eighth aspect of the present invention, there is provided the information display according to any one of the first to seventh aspects, wherein the electrical optical element is provided side by side with a transparent member, and the electrical optical element and the transparent member are able to exhibit a uniformly transparent state when all controllable pixels in the electrical optical element are in the light transmissive state.

According to a ninth aspect of the present invention, there is provided the information display according to the eighth aspect, wherein when the electrical optical element and the transparent member exhibit the uniformly transparent state as an integral unit, the electrical optical element and the transparent member have a transmittance of 50% or higher in overlapped areas. It is preferable that the transmittance is 55% or higher.

According to a tenth aspect of the present invention, there is provided a method for using the information display defined in any one of the first to ninth aspects, wherein the information display is used in a window of an automobile, a railway car, a ship or an airplane.

According to an eleventh aspect of the present invention, there is provided a method for using the information display defined in any one of the first to ninth aspects, wherein the information display is used as a guide board.

According to a twelfth aspect of the present invention, there is provided a method for using the information display defined in any one of the first to ninth aspects, wherein the information display is provided between a viewer and merchandise to display a piece of news, advertisement or information on the merchandise.

According to a thirteenth aspect of the present invention, there is provided a method for using the information display defined in any one of the first to ninth aspects, wherein the information display is used as at least a portion of an exterior material for a building.

According to a fourteenth aspect of the present invention, there is provided a method for using the information display defined in the twelfth aspect, wherein the information display is used as a show window or a showcase.

According to a fifteenth aspect of the present invention, there is provided a method for using the information display defined in any one of the first to ninth aspects, wherein the information display is used as the screen of a projector.

According to a sixteenth aspect of the present invention, there is provided a method for preparing an information display comprising providing a planar electrical optical element including a plurality of pixels, and forming each of the pixels so as to have an optical state controlled by an electrical signal; characterized in that the method comprises forming the optical element so as to have at least two optical states of a light scattering state and a light transmissive state so that each of the pixels has the optical state reversibly changed between the light scattering state and the light transmissive state; forming the optical element so as to display an information image in a planar fashion by combining the optical states of pixels; forming the optical element so that the information image is capable to be held with no electrical signal applied; and forming the pixels so that visible light has a transmittance of 60% or higher when the visible light passes from one of surfaces of the electrical optical element to the other surface through a pixel having the transparent state. It is preferable that the transmittance is 70% or higher.

According to a seventeenth aspect of the present invention, there is provided the method according to the sixteenth aspect, further comprising fabricating the electrical optical element from a chiral nematic liquid crystal by mixing a liquid crystal material and a chiral additive for the liquid crystal material so that the liquid crystal substantially exhibits the light transmissive state in a visible region by rendering selectively reflected light in a planar state to be an infrared region, controlling a cell gap so that the liquid crystal substantially exhibits the light scattering state in the visible region when the liquid crystal is in a focal conic state, sandwiching a liquid crystal layer between a pair of substrates with electrodes, and providing the liquid crystal layer with resin layers in contact therewith so as to have a pretilt angle of 60 deg or greater; and applying a voltage pulse across opposed electrodes to reversibly control the optical states of respective pixels, and causing a phase-change between the planar state and the focal conic state in the respective pixels to display an information image by combining the optical states of the pixels provided in a surface direction. In this aspect, it is preferable that the resin layer on at least one of the opposed sides is subjected to rubbing treatment.

According to an eighteenth aspect of the present invention, there is provided a liquid crystal display element comprising a chiral nematic liquid crystal layer sandwiched between a pair of substrates with groups of transparent electrodes thereon, characterized in that at least one of the groups of transparent electrodes has a resin layer provided to have a pretilt angle of 60 deg or greater, the resin layer has an alignment surface subjected to rubbing treatment provided thereon, the chiral nematic liquid crystal layer and the alignment surface subjected to rubbing treatment are provided so as to be in contact with each other, the chiral nematic liquid crystal layer has a first state wherein incoming light is selectively reflected to produce selectively reflected light and a second state wherein incoming light is scattered, and the selectively reflected light contains a wavelength in an infrared region.

According to a nineteenth aspect of the present invention, there is provided the liquid crystal display element according to the eighteenth aspect, wherein the state of transformation between the first state and the second state is controlled by a driving voltage applied across opposed transparent electrodes, and when the driving voltage is substantially 0 V, the first state or the second state is held.

According to a twentieth aspect of the present invention, there is provided the liquid crystal display element according to the eighteenth aspect or the nineteenth aspect, wherein the liquid crystal display element has a lighting system provided therebehind, I_{b}/Iₐ ≧2 is satisfied where Iₐ is a transmission amount of light that enters the chiral nematic liquid crystal layer and substantially passes through the chiral nematic liquid crystal layer in the first state, and I_{b} is a transmission amount of light that substantially passes through the chiral nematic liquid crystal layer in the second state.

According to a twenty-first aspect of the present invention, there is provided the liquid crystal display element according to the eighteenth aspect, the nineteenth aspect or the twentieth aspect, wherein each of the pair of transparent electrodes has the resin layer having an alignment surface subjected to rubbing treatment provided thereon, and each of the alignment surface subjected to rubbing treatment is provided so as to be in contact with the chiral nematic liquid crystal layer.

According to a twenty-second aspect of the present invention, there is provided the liquid crystal display element according to the eighteenth aspect, the nineteenth aspect, the twentieth aspect or the twenty-first aspect, wherein a central wavelength of the selectively reflected light is ranging from 0.7 to 1.2 μm.

According to a twenty-third aspect of the present invention, there is provided the liquid crystal display element according to any one of the eighteenth to twenty-second aspects, wherein Vₘ/d≦10 is satisfied where Vₘ (V) is the maximum voltage value of the driving voltage required for changing the optical state of the chiral nematic liquid crystal layer, and d (μm) is the thickness of the chiral nematic liquid crystal layer.

In each of the aspects, it is preferable that a glass sheet or a plastic sheet is used as the transparent member. A preferable example of the plastic sheet is a polycarbonate sheet.

In the tenth aspect, it is preferable that the information display displays information on equipment of a vehicle, driving information on a vehicle, normal advertisement or normal news.

In the tenth aspect, it is preferable that the information display is used as a display mounted on an automobile to display the operating conditions of the automobile, map information, information via Internet or the like.

In the eleventh aspect, it is preferable that the information display is used as a guide board at a hall, an event, a convention center, a wedding ceremony hall, a funnel hall, an exhibition, a museum or an aquarium.

In the eleventh aspect, it is preferable that the information display is used as a guide display at a shop.

In the eleventh aspect, it is preferable that the information display is used as a transparent partition of a counter to inform customers of services to be provided.

In the eleventh aspect, it is preferable that the information display is used as at least a portion of game equipment to inform a player of the contents of services to be provided and how to play. Examples of the game equipment are a pachinko machine and an arcade game machine.

In each of the aspects, it is preferable that a plurality of electrical optical elements are provided in layers in use.

In the twelfth aspect, it is preferable that the information display is used in at least a portion of an exterior material of a shop building or the like, to inform customers of information on merchandise provided in the shop or information related to the shop.

In each of the aspects, it is preferable that a screen area includes only a planar surface. In this case, the information display can be used, being of a planar type.

The screen area may be configured so as to include a curved surface of a transparent member. In some cases as in the case of the show window, the partition, the display mounted on an automobile or the like stated earlier, it is preferable that the transparent member includes a curved shape. In these cases, the information display can be provided so as to substantially extend along or in close contact with the curved shape of the transparent member forming the windshield or the partition.

In drawings:

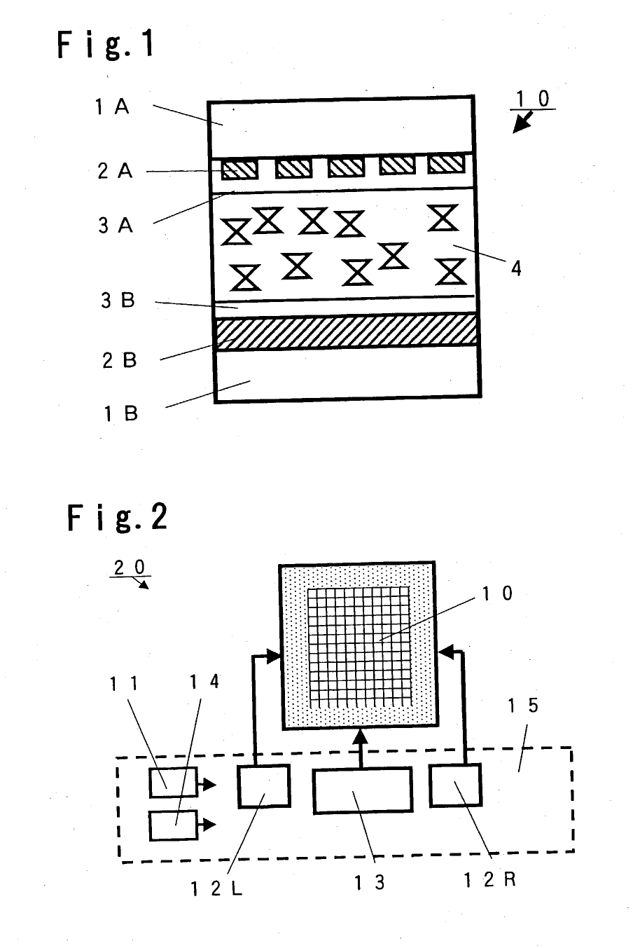

FIG. 1 is a schematic cross-sectional view of a liquid crystal optical element used in the present invention;

FIG. 2 is a block diagram showing essential parts of the information display according to the present invention;

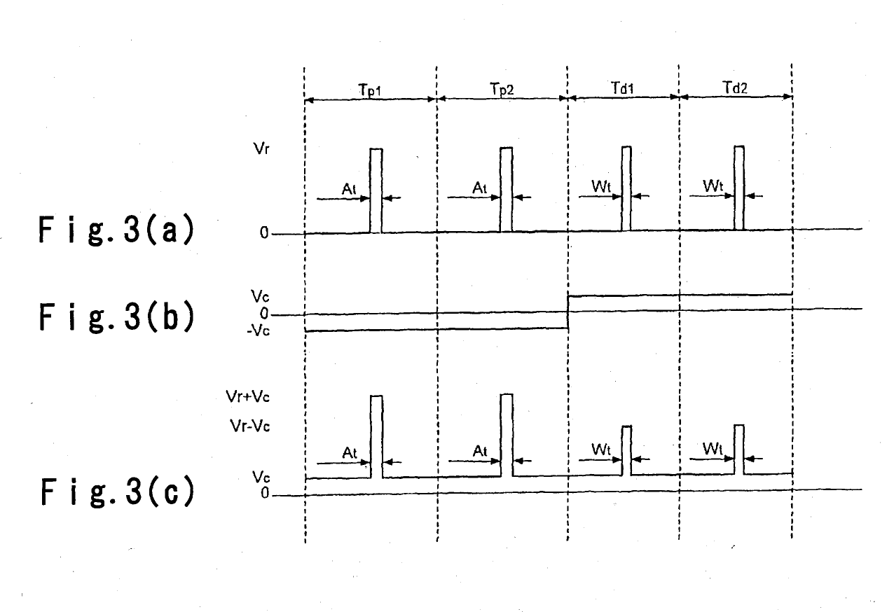

FIGS. 3(a) to 3(c) are diagrams showing a first example of the driving waveform capable of rewriting an image on the information display according to the present invention;

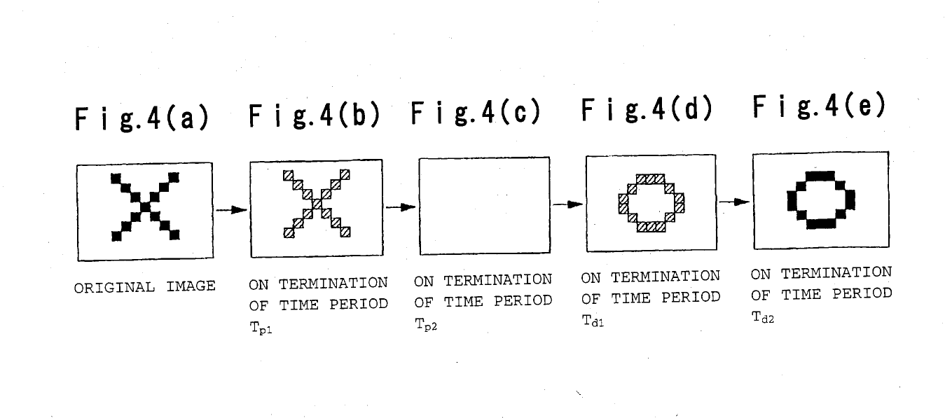

FIGS. 4(a) to 4(e) are schematic diagrams showing examples of the changes in a screen at the time of rewriting an image on the information display according to the present invention;

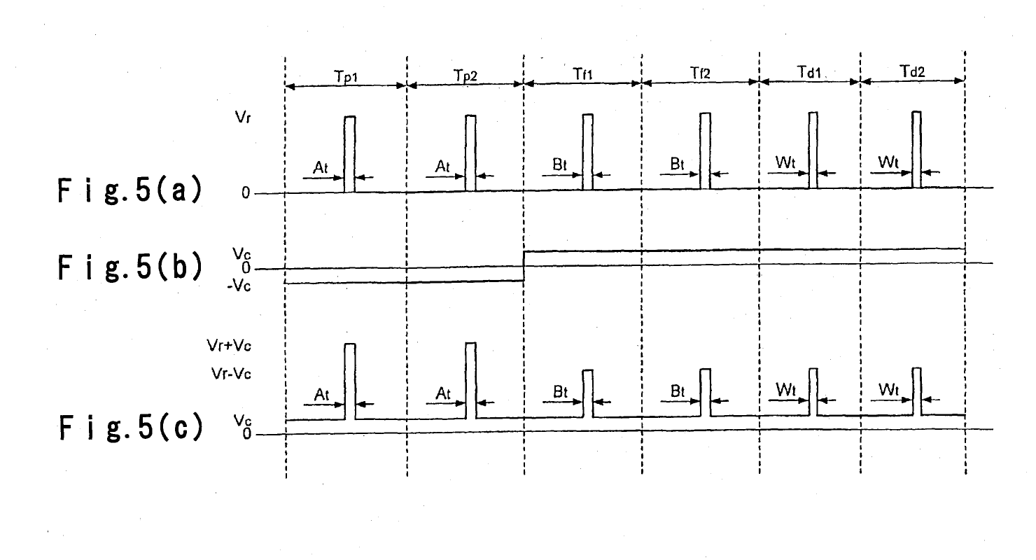

FIGS. 5(a) to 5(c) are diagrams showing a second example of the driving waveform capable of rewriting an image on the information display according to the present invention;

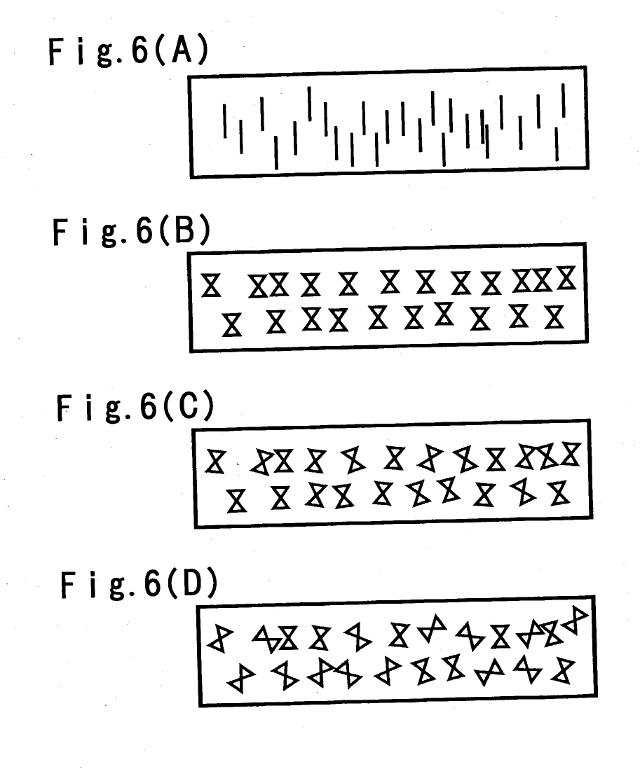

FIGS. 6(A), 6(B), 6(C) and 6(D) are schematic views showing an HO state (homeotropic state), a complete planar state, a planar state and a focal conic state of a chiral nematic liquid crystal, respectively;

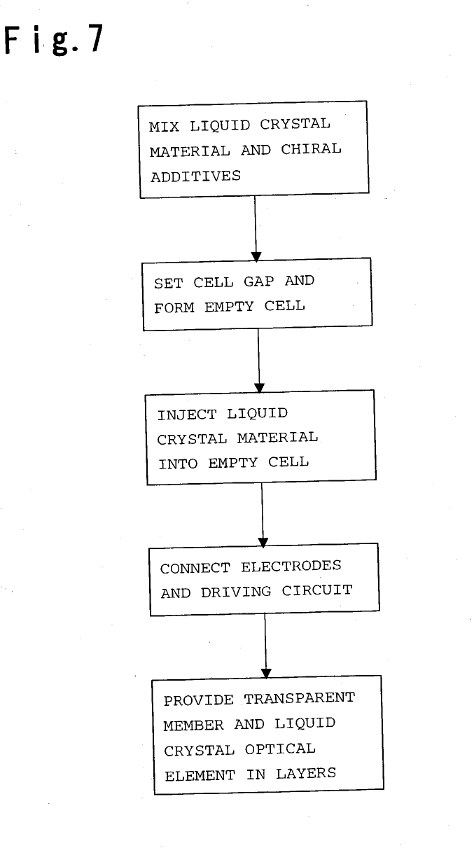

FIG. 7 is a fabrication flowchart of a chiral nematic liquid crystal display element used in the present invention;

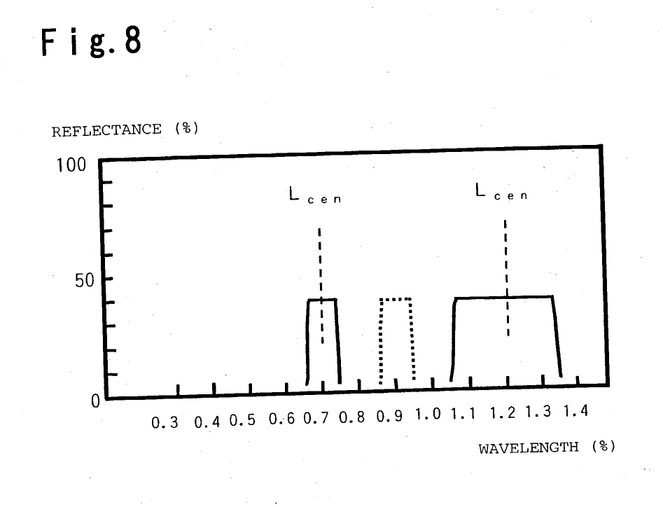

FIG. 8 is a graph showing the selective reflection properties of a chiral nematic liquid crystal display element used in the information display according to the present invention;

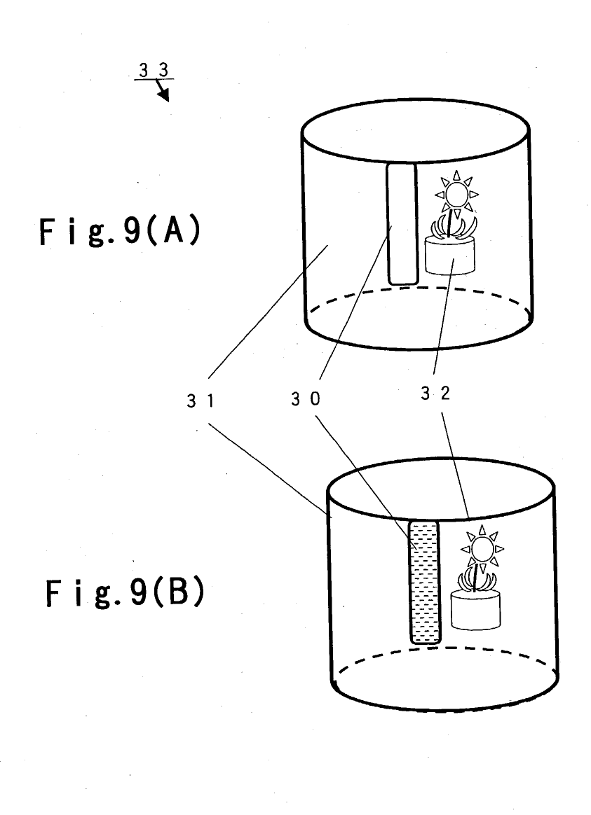

FIGS. 9(A) and 9(B) are schematic views showing how the information display according to the present invention is used in the showcase;

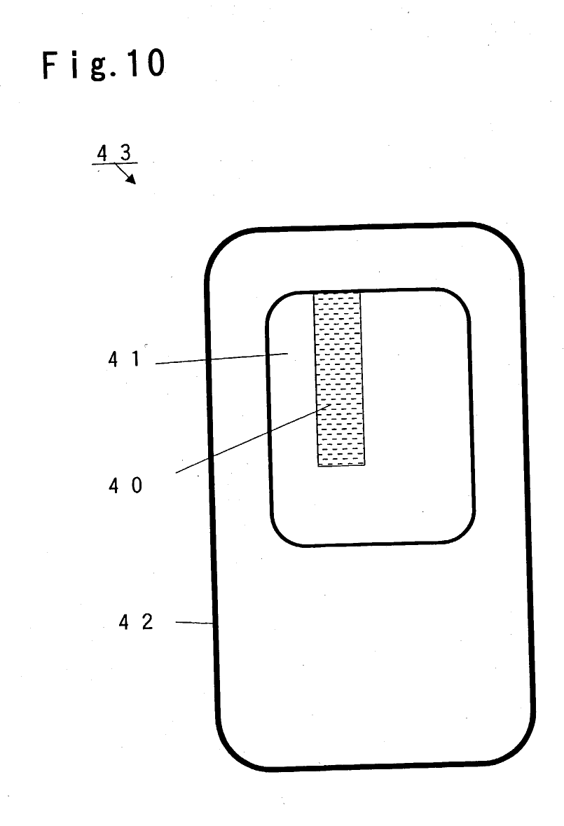

FIG. 10 is a schematic view showing how the information display according to the present invention is used in the windowpane of a door in a passenger car;

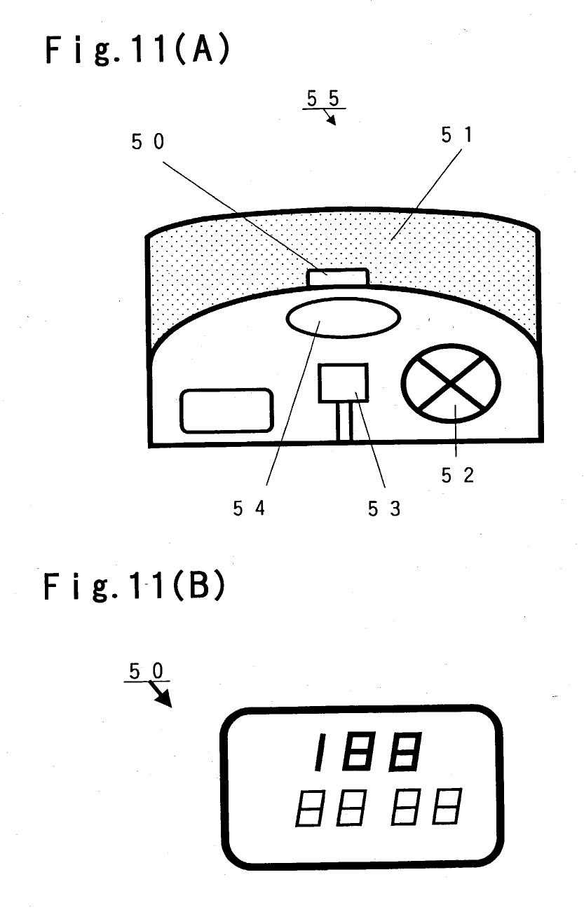

FIGS. 11(A) and 11(B) are a schematic view showing how the information display according to the present invention is used in the car navigation system in an automobile and an enlarged view of a portion of the information display, respectively;

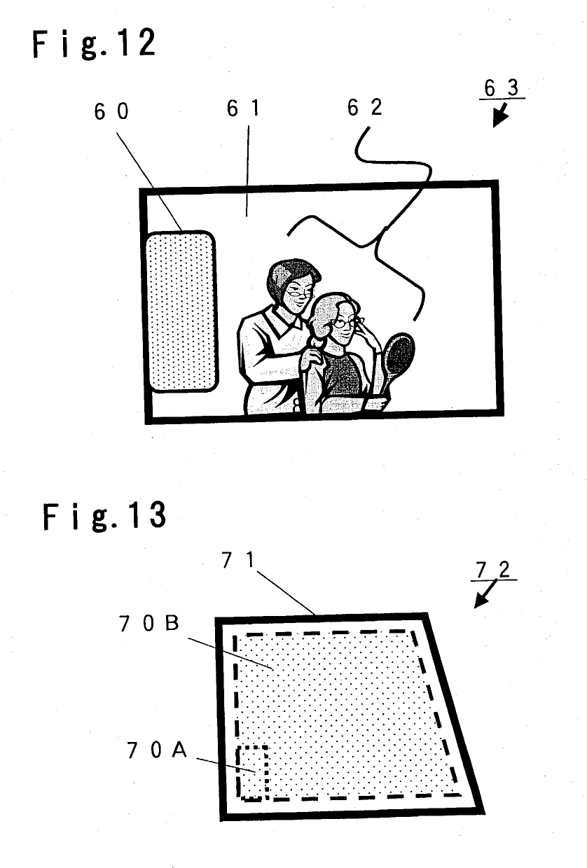

FIG. 12 is a schematic view showing how the information display according to the present invention is used in a window of a shop;

FIG. 13 is a schematic view showing how the information display according to the present invention is used in a sidelite of an automobile;

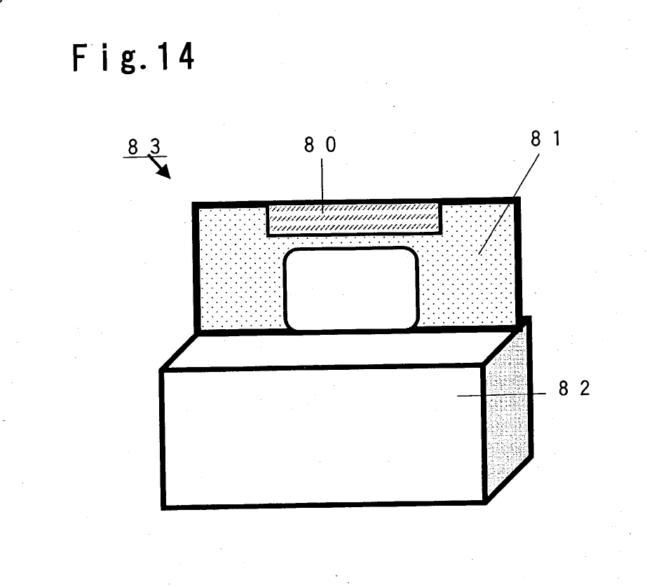

FIG. 14 is a schematic view showing how the information display according to the present invention is used in a partition of a counter;

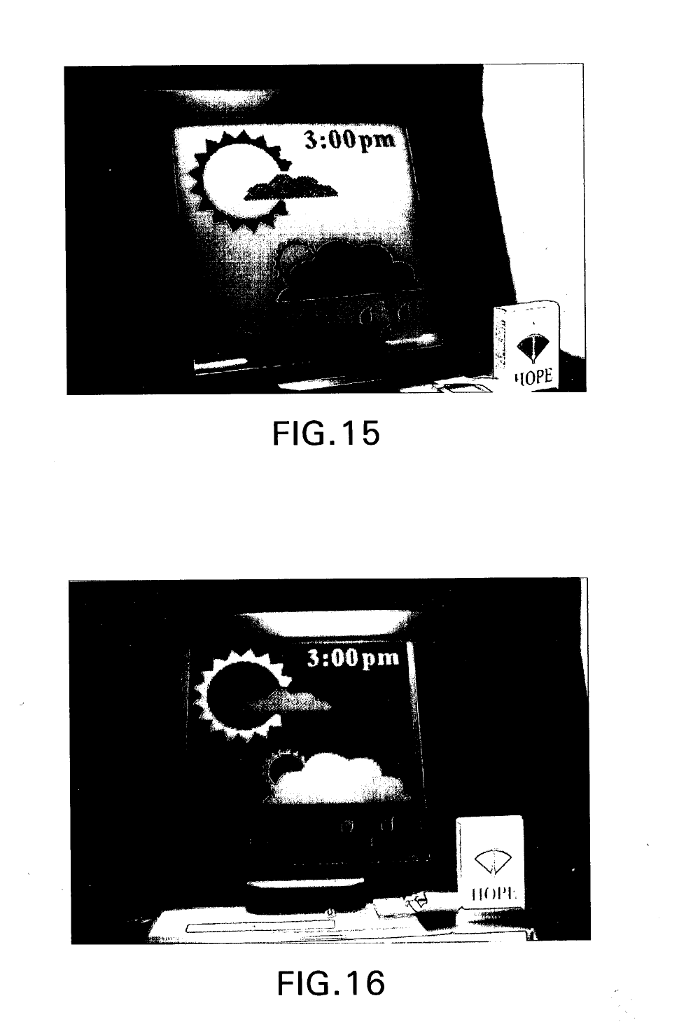

FIG. 15 is a photograph showing an example of a displayed image on the information display according to the present invention (wherein the background is in a scattering state);

FIG. 16 is a photograph showing another example of the displayed image on the information display according to the present invention (wherein the background is in a transparent state);

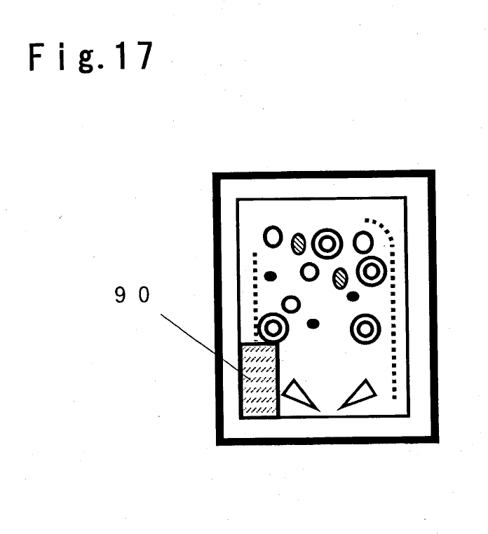

FIG. 17 is a schematic view showing how the information display according to the present invention is used in a game machine.

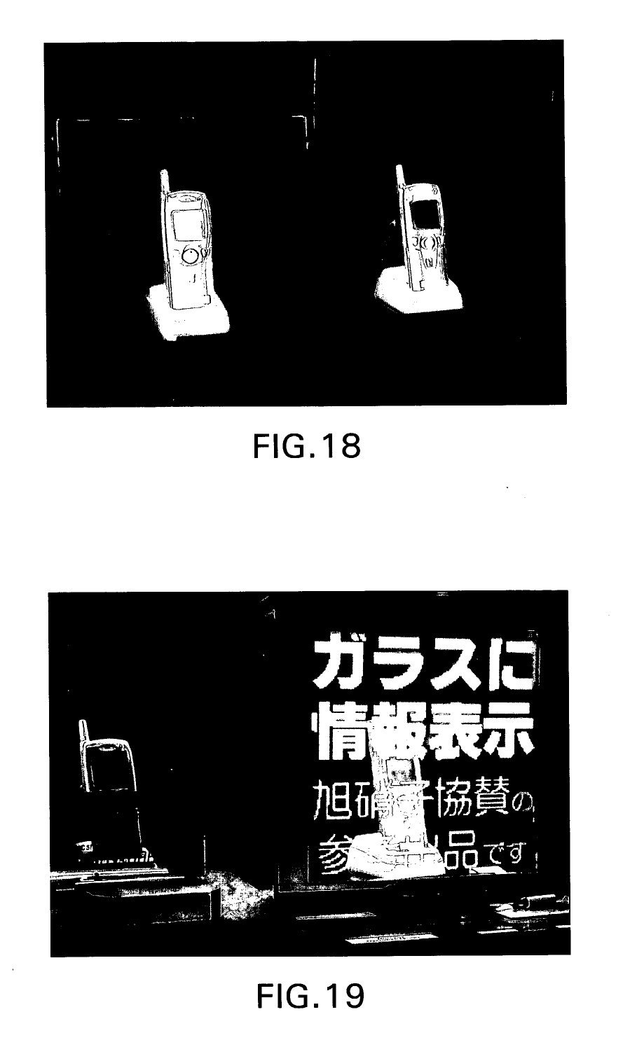

FIG. 18 is a photograph showing a comparison of a sample product according to the present invention with a sample product of a conventional LCW; and

FIG. 19 is a photograph showing the comparison of a sample product according to the present invention with a sample product of a conventional TN-LCD.

FIG. 1 shows a schematic cross-sectional view of a liquid crystal optical element used in the present invention. The liquid crystal optical element 10 shown in FIG. 1 has glass substrates 1A and 1B, electrode groups 2A and 2B, thin polymeric layers 3A and 3B, and a liquid crystal layer 4 provided therein. As the liquid crystal layer 4 is used a chiral nematic liquid crystal, which can exhibit a focal conic state and a planar state in a stable fashion.

One of the electrode groups 2A and 2B includes row electrodes (common electrodes), and the other group includes column electrodes (segment electrodes). The column electrodes and the row electrodes are provided to be perpendicular to each other. The following explanation will be made on the assumption that the electrode group 2A includes the row electrodes, and that the electrode group 2B includes the column electrodes.

It is preferable that each of the thin polymeric layers 3A and 3B has a resin layer provided thereon to have a pretilt angle of 60 deg or greater. As the resin layer providing a pretilt angle of 60 deg or greater may be used a cured resin, which has a glass transition temperature of 60° C. or higher, preferably 100° C. or higher.

It is preferable that the resin layer is subjected to rubbing treatment. Specifically speaking, a preferable example of the resin layer is polyimide, which is provided on at least one of the substrates. The pretilt angle is the alignment angle of liquid crystal molecules to a contacting surface of the resin layer where the nematic liquid crystal gets in contact with the resin layer.

When the liquid crystal is parallel to the contacting surface, the pretilt angle is referred to as 0 deg. The thin polymeric layers 3A and 3B may be both made of resin layers, such as polyimide, which are subjected to rubbing treatment and induce a pretilt angle of 60 deg or greater. It is preferable that electrical isolation layers made of, e.g., metal oxide are provided between the electrode group 2A and the thin polymeric layer 3A and between the electrode group 2B and the thin polymeric layer 3B.

This arrangement can further improve the transparency in the planar state, increasing the contrast ratio of a displayed image that is produced by transmittance and scattering. When the pretilt angle is 80 deg or greater, the liquid crystal alignment can be further stabilized.

The resin layer, which is subjected to rubbing treatment and induces a pretilt angle of 60 deg or greater, may be applied to at least one of the interfaces with the liquid crystal to exhibit sufficient transparency even to light entering from an oblique direction.

In the example stated later, a resin layer, which is subjected to rubbing treatment and induces a pretilt angle of 60 deg or greater, was applied to each of both interfaces with the liquid crystal. The present invention may adopt an arrangement wherein a resin layer, which induces a pretilt angle of 60 deg or greater and is not subjected to rubbing treatment, is applied to each of both interfaces with the liquid crystal. Additionally, the present invention may adopt an arrangement wherein a resin layer, which induces a pretilt angle of 60 deg or greater, is applied to each of both interfaces with the liquid crystal, and only the resin layer applied to one of the interfaces has been subjected to rubbing treatment.

The gap between the electrode groups is maintained by spacers or the like. The gap is preferably 2 to 15 μm. The gap is more preferably 3 to 6 μm. This is because when the gap between the electrode groups is too small, the contrast ratio in a displayed image lowers, and because when the gap between the electrode groups is too large, the driving voltage increases, and disorder is generated in the liquid crystal alignment in the planar state to slightly decrease the transparency in some cases.

The display mode is dot matrix display for instance. As long as the display mode includes scanning the common electrodes, non-full dot matrix display, such as segment display, may be adopted. Although the glass substrates may be replaced by resin substrates, it is preferable that transparent substrates are used to make maximum use of the merits of the information display according to the present invention. A combination of a glass substrate and a resin substrate may be applicable. Although the substrates may be colorless, the substrates may be colored as long as the substrates have transparency.

The spacers are sprayed on electrode surfaces at a small amount, and the four sides of the pair of substrates except for a filling port are sealed by an edge sealant made of, e.g., epoxy resin, forming an empty cell. A liquid crystal composition is filled in the empty cell by vacuum filling method. As the edge sealant, a sealant, which has transparency after curing, is preferably used since the information display can exhibit transparency even at the peripheral portion when the display is transparent.

Examples of the sealant, which has transparency after curing, are epoxy resin, acrylic resin, urethane resin, en-thiol resin and a combination of at least two of them. The curing of the sealant may be made by a thermal process, an optical process or the like.

FIG. 2 is a schematic block diagram showing the information display 20 according to an embodiment of the present invention. A controller 11 gives directions to row drivers 12L and 12R on voltage pulse inputs to the row electrodes and gives directions to a column driver 13 on voltage pulse inputs to the column electrodes. A liquid crystal power source 14 supplies necessary voltages to the row drivers 12L and 12R, and the column driver 13.

The information display 20 is formed in a substantially rectangular shape and has one side (a lower side in this figure) serving as a connection side to make connection between a driving circuit 15 and the liquid crystal optical element. The remaining three sides are non-connection sides. On the information display, portions from a screen area to the peripheral edges are substantially transparent.

In the information display 20 according to this embodiment, the row electrodes have leads alternatively provided on right and left sides of the screen for wiring. The row electrodes have the leads provided in edge portions (about 1 to 2 cm) on the right and left sides. Thus, the three portions of a portion above the screen and portions on the right and left sides of the screen are substantially transparent. The row electrodes have the leads alternatively extended one by one so that the respective electrode resistances are balanced as a whole.

The row drivers 12L and 12R, and the column driver 13 input voltage pulses into the row electrodes 2A and the column electrodes 2B of the liquid crystal optical element according to directions from the controller 11. The controller 11 selectively transforms the liquid crystal layer 4 into the planar state and the focal conic state by changing potentials applied to the respective electrodes. In the following explanation, the transparent state as the planar state is referred to as ON-display, and the light-scattering state as the focal conic state is referred to as OFF-display.

Now, the operation that is carried out to perform rewriting of a displayed image in the liquid crystal optical element 10 will be explained. First of all, the driving circuit 15 scans the row electrodes 2A in a line-at-a-time fashion so as to select the row electrodes one by one and provides portions of the liquid crystal layer 4 provided next to respective pixels with a voltage (voltage for transformation into ON-display), which transforms the liquid crystal layer into the planar state. When the voltage is applied, the liquid crystal layer 4 is changed into a homeotropic state.

When the voltage application is completed, the liquid crystal layer 4 is transformed into the planar state, being brought into ON-display (the transparent state). Since the row electrodes 2A are scanned to get all pixels into ON-display, the screen that has been displayed in the transmissive state and the scattering state up to now is erased. FIGS. 3 to 5 show driving waveforms and schematic views corresponding to the driving waveforms. FIGS. 6(A) to 6(D) are schematic views showing alignment states of a chiral nematic liquid crystal. FIG. 6(A) shows the homeotropic state of the liquid crystal, FIG. 6(B) shows the perfect planar state of the liquid crystal, FIG. 6(C) shows the normal planar state of the liquid crystal, and FIG. 6(D) shows the focal conic state of the liquid crystal.

The driving circuit 15 scans the row electrodes 2A at least one time so as to select all row electrodes 2A one by one, bringing the entire screen into ON-display. In some cases it takes some time to change the liquid crystal alignment to bring the transparent information display into the transparent state after input of the voltage signals for on-display. Even in those cases, the voltage scanning stated below may be carried out.

Subsequently, the driving circuit 15 scans the row electrodes 2A in a line-at-a-time fashion to provide desired column electrodes with a voltage corresponding to display data. Thus, the desired data is written, and the rewriting is completed. The transparent information display driving unit scans the row electrodes 2A at least one time to write display data. It is preferable in terms of improvement in contrast ratio that the scanning of the row electrodes 2A is carried out two times.

When the row selection time in the erasing step by scanning of the on-voltage is At, and when the row selection time in the subsequent writing step is Bt, it is preferable that At>Bt·1.5 is satisfied. This is because higher contrast ratio can be obtained, and because the range of applied voltages that can obtain sufficient contrast ratio can widen.

FIG. 3(a) is an embodiment of the driving waveform to be applied to one row electrode 2A, and FIG. 3(b) is an embodiment of the driving waveform to be applied to one row electrode 2A. As shown in FIGS. 3(a) and 3(b), the row drivers 12 input a voltage pulse having a voltage amplitude Vᵣ into selected row electrodes 2A, and the column driver 13 inputs a voltage pulse having a voltage amplitude V_{c} into the column electrode 2B.

At that time, Vᵣ and V_{c} are determined so as to meet the requirements of Vᵣ+V_{c}>Vₚ, Vᵣ−V_{c}=V_{F} and V_{c}<Vₛ. FIG. 3(c) shows the waveforms of the voltages, which are applied across the liquid crystal layer 4 when the voltage pulses shown in FIGS. 3(a) and 3(b) are inputted.

In a time period Tₚ₁, the row drivers 12L and 12R set the potential of selected row electrode 2A at Vᵣ and the potential of non-selected row electrodes at 0. In the time period Tₚ₁, the selection time period for the respective row electrodes 2A is Aₜ. On the other hand, the column driver 13 sets the potential of all column electrodes 2B at −V_{c} in the time period Tₚ₁. As a result, a voltage of Vᵣ+V_{c} is applied across portions of the liquid crystal layer 4 that form the pixels of the selected row electrodes as shown in FIG. 3(c), and the pixels are brought into ON-display after completion of voltage application.

A voltage of V_{c} is applied across portions of the liquid crystal layer 4 that form the pixels of the non-selected row electrodes. Even when the voltage of V_{c} is applied, the display state of the pixels makes no change. The row drivers 12L and 12R, and the column driver 13 perform the same voltage application in the scanning step during a time period Tₚ₂ as well.

FIGS. 4(a) to 4(e) are schematic views showing an embodiment of changes in the screen at the time of rewriting a displayed image. It is assumed that the screen shown in FIG. 4(a) is displayed at first. In FIG. 4(a), the background is transparent, and a portion indicated as mark X exhibits the scattering state. When the first scanning for transformation into ON-display is performed in the time period Tₚ₁, all pixels are brought into ON-display, and the entire image disappears. In the portion indicated as mark X in FIG. 4(b), the image is provided by producing the scattering state in extremely weak fashion.

In a time period T_{d1}, the row drivers 12 set the potential of the selected row electrodes 2A at Vᵣ and the potential of the non-selected row electrodes at 0. In the time period T_{d1}, the selection time period for the respective row electrodes 2A is Wₜ. Additionally, the column driver 13 sets respective column electrodes 2B at V_{c} or −V_{c}, depending to the display data of the selected rows.

As a result, a voltage of Vᵣ+V_{c} or Vᵣ−V_{c} is applied across portions of the liquid crystal layer 4 for the respective pixels of the selected rows, and the respective pixels are transformed into ON-display or OFF-display. By performing scanning of the respective row electrodes 2A, rewriting into the desired display is made. The portions of the liquid crystal layer 4 for the pixels of the non-selected rows have a voltage of V_{c} applied thereacross. Even when the voltage of V_{c} is applied, the display state of the pixels makes no change. The row drivers 12L and 12R, and the column driver 13 perform the voltage application in the scanning in the time period T_{d2} as well.

In FIG. 3(a) and 3(b) is shown the case wherein the voltage V_{c} is continuously applied to one column electrode 2B in the time periods T_{d1}, T_{d2}.

When scanning for writing display data is performed in the time period T_{d1} after scanning in the time period Tₚ₂, the desired image is displayed as shown in FIG. 4(d). When second scanning for writing the display data is performed in the time period T_{d2}, the contrast ratio is further improved, and the writing of the display data is completed as shown in FIG. 4(e).

Although is shown the case wherein the scanning step for transformation into ON-display is performed two times and the scanning step for writing display data is performed two times, the respective numbers of the scanning steps are not limited to the values as in the case.

With regard to the selection voltages for the respective row and column electrodes, it is preferable in terms of high contrast ratio that Vᵣ/V_{c} is within a range from 10 to 20.

It is preferable in terms of improved reliability of the element that the polarities of the applied voltages are reversed every selection time period. The driving method for such operation is disclosed in Japanese patent application No. 2002-274111. Now, examples of the present invention will be described.

### EXAMPLE

A Liquid crystal optical element was fabricated as follows: First, a glass substrate for the column electrode substrate with 240 transparent stripe electrodes formed thereon and a glass substrate for the row electrode substrate with 240 transparent stripe electrodes formed thereon were fabricated. The glass substrates had a thickness of 1.1 mm. Each of the glass substrates had had an inorganic thin layer as the electrical isolation layer provided on a side in contact with a liquid crystal layer, had had a polyimide resin solution (manufactured by JSR Corporation, Product No.: JALS-682-R3) applied and baked on the thin layer and had had the baked thin layer subjected to rubbing treatment. The resin layer had a film thickness of 500 Å and a pretilt angle of about 89 deg.

The rubbing directions of the substrates were set so as to be opposed when the substrates were provided in layer to have the strip electrodes on one of the substrates crossing over the strip electrodes on the other substrate. Then, resin spacers having a diameter of 4 μm were sprayed on the lower substrates. The upper substrate had had transparent epoxy resin printed in a width of about 0.4 mm at the four sides except for a filling port. An empty cell was formed by providing the glass substrates in layer so that the stripe electrodes on the upper substrate crossed over the stripe electrodes on the lower substrate, and by curing the epoxy resin.

A chiral nematic liquid crystal A (hereinbelow, referred as to the liquid crystal A) was formulated by mixing 82.2 parts by mass of a commercially available nematic liquid crystal (manufactured by Merck Japan: MJ00423, Tc=94.0° C., Δn=0.230 and ε=15.0), 8.9 parts by mass of a chiral additive represented by Chemical Formula 1 and 8.9 parts by mass of a chiral additive represented by Chemical Formula 2.

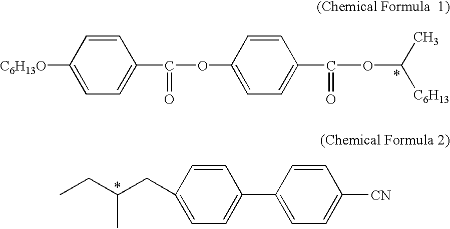

The liquid crystal A had a helical pitch length of 0.559 μm. A liquid crystal panel was fabricated by filling the liquid crystal A into the already-fabricated empty cell by vacuum filling method and sealing the filling port with an ultraviolet-cured sealant. A bipolar rectangular wave pulse having an effective voltage of 20 Vrms and a pulse width of 10 ms was applied between some of the column electrodes and some of the row electrodes in the liquid crystal panel only one time, and the liquid crystal panel was left for 10 sec as it was. As a result, the crossing portions between the respective electrodes with the voltage applied across exhibited the transparent state having high transparency. A fabricating process for the liquid crystal optical element will be shown in FIG. 7.

According to the measurement of the spectral reflection properties of the transparent portions, selective reflection having a central wavelength of about 0.91 μm was measured (see the graph of FIG. 8 showing wavelength properties). According to the measurement by use of a Schlieren optical system having a collection angle of about 5 deg, it was shown that the transmittance of the transparent portions including the glass substrates in the liquid crystal optical element was 82%. This is extremely excellent transparency.

In general, the selective reflection of a chiral nematic liquid crystal has a certain spectrum. In the present invention, it is preferable in terms of high transparency that the central wavelength of the spectrum is set within a range from 0.7 to 1.2 μm. When the central wavelength is less than 0.7 μm, the transmitted light is colored in its operation comprising the “transmission state and the scattering state” since the color of the selectively reflected light in PL (the planar state) becomes visible. In its operation comprising the transmission state and an absorption state using a polarizer (a reference example), the contrast ratio lowers since the selectively reflected light passes through the polarizer and leaks during absorption.

When the central wavelength of selective reflection light is beyond 1.2 μm, the contrast ratio in its operation comprising the transmittance state and the scattering state lowers since scattering makes weaker in the focal conic state. Even in its operation using a polarizer, the contrast ratio lowers since polarized portions of incoming light are eliminated in an insufficient fashion.

The half-width Δλ of the spectrum of selectively reflected light in a chiral nematic liquid crystal is determined by the anisotropy refractive index (Δn) and the helical pitch (P) of the liquid crystal. When a liquid crystal having a large value of Δn is used, Δλ is around 0.1 μm in some cases. From the viewpoint of fully preventing transmitted light from being colored, it is preferable that the central wavelength of selectively reflected light is 0.76 μm or longer. It is more preferable that the central wavelength is 0.80 μm or longer. FIG. 8 shows the selective reflection properties in respective wavelength regions. Generally, selectively reflected light almost exhibits selective reflection properties having a single peak. The central wavelength of the spectrum lies in a range from 0.7 to 1.2 μm. The maximum reflectance is about 40%.

In the liquid crystal optical element in this example, 240 transparent electrodes served as the column electrodes, 240 transparent electrodes served as the row electrodes, and the column driver and the row driver were connected to the column electrodes and the row electrodes, respectively. In this example, an arbitrary waveform generator manufactured by Sun-Water Corporation was used as the driving circuit including the column driver and the row driver. The driving operation was carried out as follows:

The scanning step for transformation into ON-display in order to erase a previous image was performed one time under At=16 msec. Next, the scanning step for writing was performed two times under Wt=8 msec for display drive for the liquid crystal optical element, and the power was shut off. In the scanning step for writing display data, the voltage amplitude Vᵣ applied to desired row electrodes was set at 17.9 V, and the voltage amplitude V_{c} applied to desired column electrodes was set at 1.1 V. In other words, in the scanning step for writing display data, Vᵣ+V_{c}=19 V was applied across portions of the liquid crystal with a memory effect to be brought into ON-display, and Vᵣ−V_{c}=16.8 V was applied across portions of the liquid crystal with a memory effect to be brought into OFF-display. The ratio of Vᵣ to V_{c} (Vᵣ/V_{c}) is about 16.

In the liquid crystal optical element having a combination of the respective parameters, the time period required for rewriting of display was about 8 sec (16×240+8×240×2=7,680 msec) . And the contrast ratio in its operation comprising the transmittance state and the scattering state was 4:1 according to the measurement by use of a Schlieren optical system having a collection angle of about 5 deg. There was no sticking image remained on the screen after rewriting of the display data.

Now, application examples of the information display according to the present invention will be described. Application examples 1 to 6 and 8 are cases wherein the information display is combined with a transparent member in use. For example, the information display may be incorporated into a portion of a transparent windowpane or stuck on a transparent windowpane. Preferable examples of the transparent member are a glass sheet and a transparent plastic sheet. Although the information display is preferably applicable to a flat transparent member, the information display may be also applicable to a curved transparent member.

The specific properties and standards for glass sheets are described in “Asahi Glass Company, Limited's General Brochure for Glass Sheet for Building Materials issued in 1996” (such as ordinary glass sheets, laminated glass sheets and tempered glass sheets).

In general, it is preferable that the liquid crystal optical element is sandwiched between intermediate films in a laminated glass sheet. In this case, the liquid crystal optical element is prepared as a liquid crystal sheet, using plastic substrates. The liquid crystal optical element may be used so as to be fitted into a space cut out in a portion of a transparent sheet. It is preferable that the transparent member and the liquid crystal optical element have substantially the same transparency as each other so that the transparent member and the liquid crystal optical element can be apparently recognized as a single transparent product.

### Application Example 1

This is a case wherein an information display 33 with the liquid crystal optical element according to the present invention included therein is used in the form of a transparent member forming a show window or showcase. In FIGS. 9(A) and 9(B), it is schematically shown that merchandise on sale (a potted plant) is put in a showcase.

The showcase 31 is composed of a transparent plastic sheet or a glass member. The liquid crystal optical element 30 is stuck on or incorporated into the showcase. In FIG. 9(A), it is shown that the liquid crystal optical element 30 is in a substantially transparent state so that the potted plant 32 in the showcase is sufficiently visible from outside. In FIG. 9(B), it is shown that the liquid crystal optical element 30 displays an information image, such as the name of the plant on sale and the price.

### Application Example 2

This is a case wherein a liquid crystal optical element 40 according to the present invention is used being incorporated into the windowpane 41 of a door 42 in a railway car (see FIG. 10). An information display 43 thus constructed has good transparency at the passage for passengers. Additionally, this case is advantageous in that information required for passengers can be displayed on the windowpane, improving user-friendliness and safety.

### Application Example 3

In FIGS. 11(A), it is schematically shown how an information display 55 according to the present invention is provided on the instrument panel of an automobile. The information display has a liquid crystal optical element 50 provided above a steering wheel 52, an instrument panel 54 and a car navigation system 53. The information display can display positional information from the satellites thereon in real time at a location where a driver can take an easy look. In this case, when the liquid crystal optical element 50 is transformed into the transparent state, the liquid crystal optical element is not a bar to the driver's vision to outside since the liquid crystal optical element merges into a windshield 51 as a substantially uniformly transparent member. The liquid crystal optical element 50 may additionally display speed information and time thereon (see FIG. 11(B)).

### Application Example 4

In FIG. 12 is shown an information display 63 according to the present invention. In this example, a liquid crystal optical element 60 is incorporated into a portion of a glass sheet 61 on the exterior side of a shop, such as a barbershop. When the liquid crystal optical element 60 becomes in a substantially transparent state, the atmosphere 62 in the shop becomes clearly invisible from a street side. When the liquid crystal optical element 60 displays certain information thereon, information, such as the contents of services provided in the shop, the advertisement of merchandise and bargain days, can be displayed directly on a surface that appears to be an integral part of a wall made of glass. In this embodiment, the information display may be provided so as to be fitted into a hole formed in a portion of a non-transparent wall surface.

### Application Example 5

In FIG. 13, it is shown how an information display 72 according to the present invention is used. Liquid crystal optical elements 70A and 70B according to the present invention are incorporated into a portion and the entire front side of a sidelite 71, respectively. When external light is bright and dazzling, the effective screen area of the liquid crystal optical element 70B may be transformed into the scattering state in its almost entirety to decrease the amount of solar radiation to a person in the automobile. The liquid crystal optical element 70A, which is provided at a corner of the sidelite 71, may display information, such as the name of a user, and the name of a company. The information display 72 thus constructed is advantageous in having a high functionality.

### Application Example 6

In FIG. 14, it is shown how an information display 83 according to the present invention is used. This is a case wherein the information display is provided at a partition 81 for a bank teller's window 82. A liquid crystal optical element 80 according to the present invention may sequentially display information, such as a current date, a weather forecast, an exchange rate and current interest rates, thereon. This arrangement can realize an atmosphere having a feeling of comfort and a feeling of open-mindedness since a customer can catch the latest information at his or her eyes and see the inside of the teller's window through the partition.

### Application Example 7

FIGS. 15 and 16 are photographs showing how an information display according to the present invention is realized. The information display in this application example may be provided in a place, such as a shop, to provide a user with the weather forecast of a current day. For example, the liquid crystal optical element may display the weather forecast of a current day, rewriting a displayed image every one hour. In FIGS. 15 and 16, the scattering state and the transparent state of each of the pixels of the liquid crystal optical element on display are completely reversed.

The information display in the application example is not formed in a rectangular shape having one side serving as a connection side but is formed in a rectangular shape having four sides surrounded by a frame. The information display in the application example may be formed in a rectangular shape having one side serving as a connection side and having electrode groups connected to a driving circuit. In this case, the row electrodes, which are provided in right and left directions, are divided into two groups of electrodes having an odd line number and electrodes having an even line number, the row electrodes have leads extended from a right or left edge, and the leads are wired up to be directed to the connection side via either one of the lateral sides of one of the substrates. The leads of the column electrodes are conductively connected to the other substrate on the connection side by transfer beads included in the edge sealant.

This arrangement offers advantages in terms of fabrication and design since the driving circuit for all electrodes can be provided on one of the substrates. This design allows portions close to three sides except for the connection side to become substantially transparent. This arrangement is advantageous since the liquid crystal optical element and a transparent member can be combined so as to appear as a single transparent article. This arrangement is advantageous since the liquid crystal optical element can be easily combined with a transparent member.

A larger size of information display unit can be provided by using a plurality of information displays having portions close to the three sides formed as being transparent as in this application example and continuously providing the information displays side by side. In this case, it is preferable that the connection sides are located on a common side. It is preferable that the information display according to the present invention has the connection side provided close to an end portion of a window or an exterior material.

In the experiment of the information display in this application example, the liquid crystal optical element was configured so that scattering pixels were visible in white on a black background. Even when an image was rewritten as required in the information display, no sticking image, such as an icon for a weather forecast, was remained in a new displayed image.

For example, when an image is displayed in a size of 20 cm in length and 20 cm in breadth, an information image required for telling a weather forecast (graphical marks showing the sun, rain, two kinds of clouds and rain drops, and time indication) can be written by use of 160 column electrodes and 160 row electrodes. In this case, the size of one pixel is 1.25 mm in length and 1.25 mm in breadth.

### Application Example 8

A liquid crystal optical element 90 according to the present invention is incorporated into a portion of a front glass sheet of a pachinko machine or a pinball machine (see FIG. 17). This arrangement can timely provide amusement or an advertisement to a player. In this case, the optical element is no obstacle to playing with the machine, and the optical element can provide an information display, which appears to be as a transparent glass sheet in the entirety and gives no feeling of discomfort. This arrangement is advantageous since a displayed image can be held even after shutting off the power. The optical element may be used so as to mask a portion of the surface or the entire surface of game equipment.

Comparison A

FIG. 18 is a photograph showing that a sample product of the information display according to the present invention and a sample product of a liquid crystal window including a liquid crystal/polymer composite (about 62% of liquid crystal and about 38% of a polymer in mass ratio) were disposed side by side. After the sample product according to the present invention was brought into the transparent state in the entirety, the power was shut off to be the sample product into a memory state (the planar state in the entirety), and the sample product is held in the transparent state.

The photograph was taken from an oblique direction of about 30 deg and shows a difference in vision between articles (cellular phones) behind both sample products. Table 1 shows values of transmittance properties.

TABLE 1

| | | Light |
|---|---|---|
| | Light | transmittance in |
| | transmittance in a | oblique direction |
| Structure | direction of 0 deg | of about 30 deg |
| Sample product | 83% | 80% |
| according to the | | |
| present invention | | |
| Sample product of | 35% | |
| TN-LCD | | |
| Sample product of | 73% | 65% |
| LCW (dispersed | | |
| liquid crystal | | |
| display element) | | |

Comparison B

FIG. 19 is a photograph showing that a sample product of the liquid crystal display element according to the present invention and a sample product of a conventional one (a sample of a transmissive type TN liquid crystal display element) were disposed. In the photograph, the sample on the left side is the TN liquid crystal display element.

The sample product according to the present invention displayed the characters in white on a transparent background. The reversal contrast of the image can be obtained by its operation. The shown sample can display not only a character but also a graphic image or a pattern image since the sample includes an electrode arrangement in a full dot matrix pattern.

In accordance with the present invention, the information display is provided as having a feeling of transparency, allowing a user to see circumstances behind the display and displaying required information in a conspicuous fashion. The display has an extremely simple shape and needs no excessive space.

The information display can offer a feeling of comfort, a feeling of safety and a feeling of open-mindedness to a user since he or she can see the circumstances behind the display.

The information display can drastically improve an advertising function since the display can display an information image on, e.g., an exterior material made of glass, which has not been impossible in the past.

The information display can be provided at a position close to the windshield of an automobile to display required information in a conspicuous fashion, though it has been difficult to provide an information display at that position.

The entire disclosures of Japanese Patent Application No. 2001-373274 filed on Dec. 6, 2001 and Japanese Patent Application No. 2002-282562 filed on Sep. 27, 2002 including specifications, claims, drawings and summaries are incorporated herein by reference in their entireties.

What is claimed is:

1. An information display comprising:
a planar electrical optical element including a plurality of pixels, each of the pixels having an optical state controlled by an electrical signal;
the optical element having at least two optical states of a light scattering state and a light transmissive state, each of the pixels having the optical state reversibly changed between the scattering state and the light transmissive state;
information being displayed in a planar fashion by combining the optical states of pixels; and
the information being capable to be held with no electrical signal applied, and visible light having a transmittance of 60% or higher when the visible light passes from one of surfaces of the electrical optical element to the other surface through a pixel having the light transmissive state.

2. The information display according to claim 1, wherein the electrical optical element comprises a liquid crystal optical element, which has a liquid crystal sandwiched between a pair of substrates with transparent electrodes provided thereon, the liquid crystal having a memory effect in its operation capable of holding two or more optical states with no voltage applied, the optical states being changed by a voltage pulse.

3. The information display according to claim 2, wherein the liquid crystal is a chiral nematic liquid crystal.

4. The information display according to claim 3, wherein when the chiral nematic liquid crystal exhibits a planar state, at least part of selectively reflected light contains infrared light.

5. The information display according to claim 3, wherein a resin layer is arranged to have a pretilt angle of 60 deg or greater in contact with the chiral nematic liquid crystal.

6. The information display according to claim 5, wherein the resin layer has at least one side subjected to rubbing treatment.

7. The information display according to claim 2, wherein the transparent electrodes are configured to display an information image in a dot matrix pattern by use of matrix electrodes, or the transparent electrodes are configured to display an information image in a segment pattern by use of segment electrodes.

8. The information display according to claim 1, wherein the electrical optical element is provided side by side with a transparent member, and the electrical optical element and the transparent member are able to exhibit a uniformly transparent state when all controllable pixels in the electrical optical element are in the transparent state.

9. The information display according to claim 8, wherein when the electrical optical element and the transparent member exhibit the uniformly transparent state as an integral unit, the electrical optical element and the transparent member have a transmittance of 50% or higher in overlapped areas.

10. A method for using the information display defined in claim 1, wherein the information display is used in a window of an automobile, a railway car, a ship or an airplane.

11. A method for using the information display defined in claim 1, wherein the information display is used as a guide board.

12. A method for using the information display defined in any one of claims 1 to 9, wherein the information display is provided between a viewer and merchandise to display a piece of news, advertisement or information on the merchandise.

13. A method for using the information display defined in claim 1, wherein the information display is used as at least a portion of an exterior material for a building.

14. A method for using the information display defined in claim 12, wherein the information display is used as a show window or a showcase.

15. A method for using the information display defined in any claim 1, wherein the information display is used as a screen of a projector.

16. A method for preparing an information display comprising:
providing a planar electrical optical element including a plurality of pixels, and forming each of the pixels so as to have an optical state controlled by an electrical signal;
forming the optical element so as to have at least two optical states of a light scattering state and a light transmissive state so that each of the pixels has the optical state reversibly changed between the light scattering state and the light transmissive state;
forming the optical element so as to display an information image in a planar fashion by combining the optical states of pixels; and
forming the optical element so that the information image is capable to be held with no electrical signal applied, and forming the pixels so that visible light has a transmittance of 60% or higher when the visible light passes from one of surfaces of the electrical optical element to the other surface through a pixel having the transparent state.

17. The method according to claim 16, further comprising:
fabricating the electrical optical element from a chiral nematic liquid crystal by mixing a liquid crystal material and a chiral additive for the liquid crystal material so that the liquid crystal substantially exhibits the light transmissive state in a visible region by rendering selectively reflected light in a planar state to be an infrared region, controlling a cell gap so that the liquid crystal substantially exhibits the light scattering state in the visible region when the liquid crystal is in a focal conic state, sandwiching a liquid crystal layer between a pair of substrates with electrodes, and providing each of opposite sides of the liquid crystal layer with resin layers in contact therewith, which make a pretilt angle of 60 deg or greater; and
applying a voltage pulse across opposed electrodes to reversibly control the optical states of respective pixels, and causing a phase-change between the planar state and the focal conic state in the respective pixels to display an information image by combining the optical states of the pixels provided in a surface direction.

18. A liquid crystal display element comprising:
a chiral nematic liquid crystal layer sandwiched between a pair of substrates with groups of transparent electrodes thereon;
at least one of the groups of transparent electrodes having a resin layer provided to have a pretilt angle of 60 deg or greater;
the resin layer having an alignment surface subjected to rubbing treatment provided thereon;
the chiral nematic liquid crystal layer and the alignment surface subjected to rubbing treatment being provided so as to be in contact with each other;
the chiral nematic liquid crystal layer having a first state wherein incoming light is selectively reflected to produce selectively reflected light and a second state wherein incoming light is scattered; and
the selectively reflected light containing a wavelength in an infrared region.

19. The liquid crystal display element according to claim 18, wherein the state of transformation between the first state and the second state is controlled by a driving voltage applied across opposed transparent electrodes, and when the driving voltage is substantially 0 V, the first state or the second state is held.

20. The liquid crystal display element according to claim 18, wherein the liquid crystal display element has a lighting system provided therebehind, I_{b}/Iₐ≧2 is satisfied where Iₐ is a transmission amount of light that enters the chiral nematic liquid crystal layer and substantially passes through the chiral nematic liquid crystal layer in the first state, and I_{b} is a transmission amount of light that substantially passes through the chiral nematic liquid crystal layer in the second state.

21. The liquid crystal display element according to claim 18, the nineteenth aspect or the twentieth aspect, wherein each of the pair of transparent electrodes has the resin layer having an alignment surface subjected to rubbing treatment provided thereon, and each of the alignment surface subjected to rubbing treatment is provided so as to be in contact with the chiral nematic liquid crystal layer.

22. The liquid crystal display element according to claim 18, wherein a central wavelength of the selectively reflected light is ranging from 0.7 to 1.2 μm.

23. The liquid crystal display element according to claim 18, wherein Vm/d≦10 is satisfied where Vm (V) is the maximum voltage value of the driving voltage required for changing the optical state of the chiral nematic liquid crystal layer, and d (μm) is the thickness of the chiral nematic liquid crystal layer.

24. The liquid crystal display element according to claim 18, wherein said resin layer provided to have a pretilt angle of 80 deg or greater.

25. The liquid crystal display element according to claim 24, wherein both sides of said chiral nematic liquid crystal layer is contact with said resin layer provided on each substrate.

26. The method according to claim 17, wherein the selectively reflected light in the planar state has a spectrum set in the infrared region by controlling a mixing ratio between the liquid crystal material and the chiral additive.

27. A liquid crystal display element comprising:
a chiral nematic liquid crystal layer which is reversibly changeable between a light transmissive state and a light scattering state; and
the liquid crystal display element having a rectangular outer shape, the outer shape having three side edges formed as being transparent and the three side edges being capable of exhibiting the light transmissive state integrally with a display area.
